(19) United States
(12) Patent Application Publication
(10) Pub. No.: US 2013/0053279 A1
(43) Pub. Date: Feb. 28, 2013

(54) BIOCHIP AND FABRICATING METHOD THEREOF

(71) Applicant: Chin-Feng Wan, Hsinchu City (TW)

(72) Inventor: Chin-Feng Wan, Hsinchu City (TW)

(21) Appl. No.: 13/560,711

(22) Filed: Jul. 27, 2012

(30) Foreign Application Priority Data
Aug. 26, 2011 (TW) 100130793

(51) Int. Cl. C40B 50/18; C40B 40/10; C40B 40/06

(52) U.S. Cl. 506/16; 506/18; 506/32

(57) ABSTRACT

A biochip includes a substrate, a photoresist pattern layer, a blocking layer, a bonding layer, at least one linker molecule, and a probe molecule. The photoresist pattern layer is formed on a surface of the substrate. The blocking layer is formed on the surface of the substrate at a region uncovered by the photoresist pattern layer. The bonding layer is covalently attached to the photoresist pattern layer. The at least one linker molecule is covalently bonded to the binding layer. The probe molecule is covalently bonded to the at least one linker molecule for specifically reacting with a to-be-detected molecule.

### FIELD OF THE INVENTION

The present invention relates to a biochip and a fabricating method thereof, and more particularly to a microarray biochip and a fabricating method thereof.

### BACKGROUND OF THE INVENTION

A biochip is a miniaturized device that allows specific biochemical reactions between specified biological materials (e.g. nucleic acid or protein) and other to-be-detected biological samples by employing Micro Electro Mechanical System. After the reaction signals are quantified by various sensors, the possible biochemical reactions can be realized. In other words, the biochip is a miniaturized device fabricated by a microelectronic technology, a microfluidic technology and a biological technology. The applications of the biochip cover the disease diagnosis, the gene probe, the pharmaceutical technology, the microelectronic technology, the semiconductor technology, the computer technology, and the like.

Generally, the substrate of the biochip is for example a silicon chip substrate, a glass substrate or a polymeric substrate. In addition, by a miniaturizing technology, biological molecules (e.g. nucleic acid or protein) are integrated into the substrate to be served as biological probes. As known, the biochip has many benefits. For example, the biochip has small volume. Moreover, the biochip enables the researchers to quickly perform parallel analysis on large numbers of biological samples for a variety of purposes such as biological treatment, biological analysis, biological detection, new drug development and environmental monitoring.

Generally, biochips are classified into two types, i.e. a lab-on-a-chip and a microarray biochip. The lab-on-a-chip is a device that integrates one or several laboratory functions on a single chip. The goal of the microarray biochip is to simultaneously acquire large numbers of detection data. Depending on the probe types, the microarray biochips may be divided into two types, i.e. a gene chip and a protein chip. In the microarray biochip, different DNA or protein molecules are closely fixed on an area of several square centimeters at a spacing interval of several hundred micrometers to be served as the biological probes. After to-be-detected biological samples chemically react with the probes of the biochip, the reaction signals may be analyzed by a scanning instrument and an analyzing instrument. Consequently, the researchers can quickly acquire the information about large numbers of gene sequences or protein behaviors in a short time period.

The biochip is a very successful example of the application of a semiconductor device on the biomedical science. However, the conventional biochip has some drawbacks. For example, after a photoresist pattern layer is formed on a substrate, the surface of the photoresist pattern layer is directly connected with a biological material in order to detect the to-be-detected molecule. Since the adhesion between the biological material and the photoresist material is insufficient, the detecting precision and stability of the biochip are usually unsatisfied.

Therefore, there is a need of providing an improved biochip so as to obviate the above drawbacks.

### SUMMARY OF THE INVENTION

The present invention provides a biochip and a fabricating method thereof. The biochip of the present invention has enhanced precision and stability. Moreover, since the fabricating cost is reduced and the fabricating process is simplified, the applications of the biochip of the present invention are expanded.

In accordance with an aspect of the present invention, there is provided a biochip. The biochip includes a substrate, a photoresist pattern layer, a blocking layer, a bonding layer, at least one linker molecule, and a probe molecule. The photoresist pattern layer is formed on a surface of the substrate. The blocking layer is formed on the surface of the substrate at a region uncovered by the photoresist pattern layer. The bonding layer is covalently attached to the photoresist pattern layer. The at least one linker molecule is covalently bonded to the binding layer. The probe molecule is covalently bonded to the at least one linker molecule for specifically reacting with a to-be-detected molecule.

In accordance with another aspect of the present invention, there is provided a method of fabricating a biochip. The method includes the following steps: (a) providing a substrate, (b) forming a photoresist pattern layer on a surface of the substrate, (c) forming a blocking layer on the surface of the substrate at a region uncovered by the photoresist pattern layer, (d) forming a bonding layer on the photoresist pattern layer, wherein the bonding layer is covalently attached to the photoresist pattern layer, (e) forming at least one linker molecule on the binding layer, wherein the linker molecule is covalently bonded to the binding layer, and (f) forming a probe molecule on the linker molecule, wherein the probe molecule is covalently bonded to the linker molecule.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic view illustrating the structure of a biochip according to an embodiment of the present invention;

FIG. 2 is a flowchart illustrating a method of fabricating a biochip according to an embodiment of the present invention;

FIGS. 3A-3F are schematic views illustrating the steps of the method of fabricating a biochip according to an embodiment of the present invention;

FIG. 4A schematically illustrates the reaction between the linker molecule and the probe molecule in the fabrication of the biochip of the present invention; and

FIG. 4B schematically illustrates the reaction between the probe molecule of the biochip and the to-be-detected molecule.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

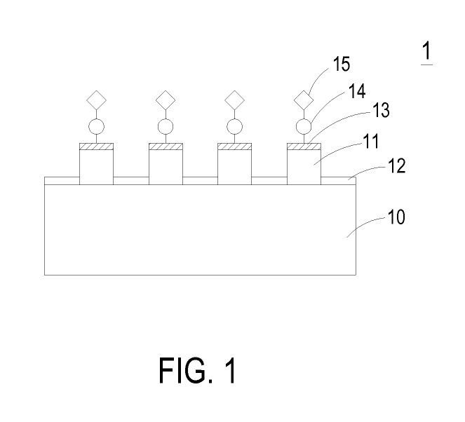

FIG. 1 is a schematic view illustrating the structure of a biochip according to an embodiment of the present invention. As shown in FIG. 1, the biochip 1 at least comprises a substrate 10, a photoresist pattern layer 11, a blocking layer 12, a bonding layer 13, a linker molecule 14, and a probe molecule 15. The photoresist pattern layer 11 is formed on a surface of the substrate 10. The blocking layer 12 is formed on the surface of the substrate at the region uncovered by the photoresist pattern layer 11. The bonding layer 13 is covalently attached to the photoresist pattern layer 11. The linker molecule 14 is covalently bonded to the binding layer 13. The probe molecule 15 is covalently bonded to the linker molecule 14 for specifically reacting with a to-be-detected molecule.

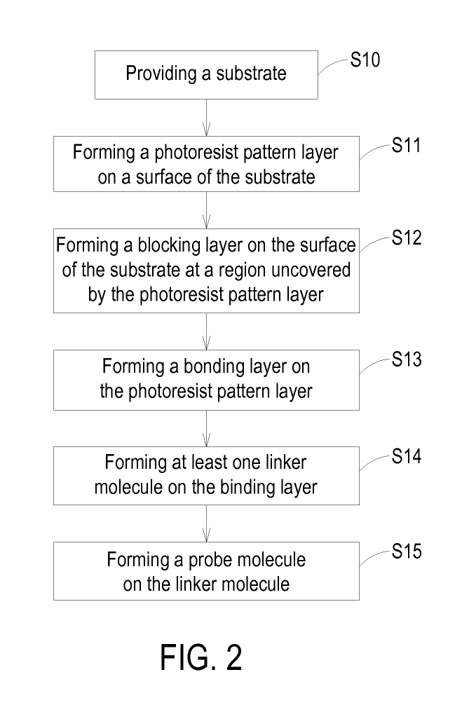

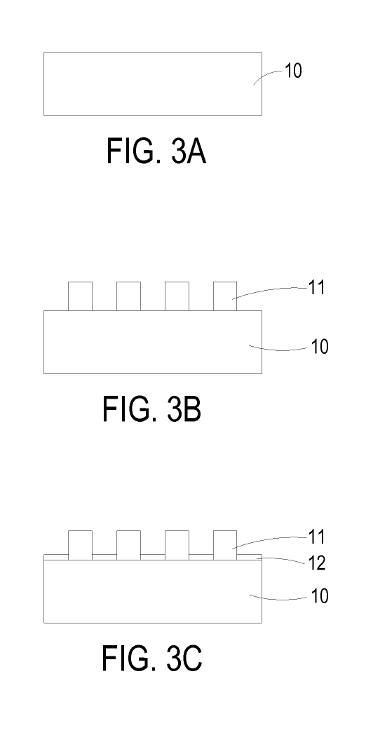

Hereinafter, a method of fabricating the biochip of the present invention will be illustrated with reference to FIG. 2 and FIGS. 3A-3F. FIG. 2 is a flowchart illustrating a method of fabricating a biochip according to an embodiment of the present invention. FIGS. 3A-3F are schematic views illustrating the steps of the method of fabricating a biochip according to an embodiment of the present invention.

Firstly, as shown in FIG. 3A, a substrate 10 is provided (see also the step S10 of FIG. 2). The substrate 10 is for example a glass substrate, a silicon chip substrate, a plastic substrate or a polymeric substrate. Then, as shown in FIG. 3B, a photoresist pattern layer 11 is formed on a surface of the substrate 10 by a lithography process (see also the step S11 of FIG. 2). The step of forming the photoresist pattern layer 11 comprises sub-steps of forming a photoresist layer on the surface of the substrate 10, irradiating a portion of the photoresist layer to result in polymerization of the photoresist layer, and using a developing solution to remove the unpolymerized photoresist layer. The photoresist pattern layer 11 is employed to define a microarray structure. Each spot of the microarray structure has a diameter of about 10-300 μm and a height of 1-5 μm. For example, the photoresist pattern layer 11 is made of an epoxy-based photoresist material such as a SU-8 photoresist material.

For performing the lithography process, a mask is necessary for pattern transfer. Before the lithography process is performed, a predetermined microstructure pattern is formed on a mask, and the surface of the substrate 10 is cleaned to enhance the adhesion between the substrate 10 and the photoresist material. Then, the surface of the substrate 10 is coated with a photoresist material uniformly by a photoresist spinner. After a soft baking process is performed, the predetermined microstructure pattern of the mask is irradiated by a UV beam, so that the predetermined microstructure pattern of the mask is transferred to the photoresist material. After the photoresist material is treated with a developing solution and a hard baking process is performed, the designed photoresist pattern layer 11 is produced.

Alternatively, in some other embodiments, the photoresist pattern layer 11 may be produced by a maskless lithography process. For performing the maskless lithography process, the mask used in the lithography process is replaced by a digital micromirror device. The profile of the photoresist pattern layer of the polymerization is controlled by the control chip of the digital micromirror device. A UV beam is transmitted through a condenser lens, the digital micromirror device, an aperture, a collimating lens and a reflective mirror and other optical elements, and projected on a sample platform of an upside-down fluorescence microscopy. Then, the orientation of the digital micromirror device and the exposure image pattern of the incident light are controlled by a self-written computer program. Consequently, the photoresist pattern layer 11 is formed on the surface of the substrate 10.

Then, as shown in FIG. 3C, a blocking layer 12 is formed on the surface of the substrate 10 at the region uncovered by the photoresist pattern layer 11 (see also the step S12 of FIG. 2). The surface of the blocking layer 12 has no functional groups. The blocking layer 12 may block the to-be-detected molecule from being attached thereon through a non-specific reaction. Consequently, the subsequent biological detecting reactions may precisely occur at the microarray structure, which is defined by the photoresist pattern layer 11. In an embodiment, the blocking layer 12 may be formed on the surface of the photoresist pattern layer 11 by silanization. For example, the blocking layer 12 may be formed through the reaction between dimethyldichlorosilane and the substrate 10. Moreover, the blocking layer 12 may be formed within the spaces between adjacent spots of the microarray structure (e.g. 50-150 μm). In some other embodiments, the blocking layer 12 is made of silicon oxide, polyvinylpyrrolidone (PVP), bovine serum albumin (BSA) or skim milk powder.

Then, as shown in FIG. 3D, a bonding layer 13 is covalently attached to the photoresist pattern layer 11 (see also the step S13 of FIG. 2). The bonding layer 13 has at least one active functional group (a hydroxyl group or an amino group) to be connected with the linker molecule 14. For example, the bonding layer 13 is made of 3-aminopropyltriethoxysilane, (APTES) such as 3-[Bis(2-hydroxyethyl)amino] propyl-triethoxysilane. The bonding layer 13 may be covalently attached to the oxygen atoms on the photoresist pattern layer 11. Moreover, the bonding layer 13 has hydroxyl groups as active functional groups. Consequently, the bonding layer 13 may be connected with the linker molecule 14. Alternatively, in some other embodiments, the bonding layer 13 is made of glycidoxypropyltrimethoxysilane, n-octadecyltrichlorosilane or chlorodimethyloctylsilane.

Then, as shown in FIG. 3E, at least one linker molecule 14 is covalently bonded to the binding layer 13 (see also the step S14 of FIG. 2). The linker molecule 14 is covalently bonded to the active functional group of the binding layer 13. For example, the linker molecule 14 is 1,4-phenylene diisothiocyanate (PDITC). An isocyanato group of the linker molecule 14 may be connected with the active functional group of the probe molecule 15 (e.g. the N-terminal amino group of a protein molecule). In some other embodiments, the linker molecule 14 is glutaraldehyde, 1-methylimidazole, 4-hydroxybenaldehyde or 4-aminobenzylamine.

Afterwards, as shown in FIG. 3F, a probe molecule 15 is covalently bonded to the linker molecule 14 for specifically reacting with a to-be-detected molecule (see also the step S15 of FIG. 2). Meanwhile, the biochip of the present invention is fabricated. Dependent on the biological detection target, the probe molecule 15 may be a nucleic acid or a protein. Consequently, the probe molecule 15 may be used in genetic testing, antibody-antigen reaction detection, enzyme-substrate reaction detection, receptor-ligand reaction detection, aptamer-target reaction detection, cellular reaction detection or protein-protein reaction detection. In other words, the biologic molecule capable of specifically reacting with the to-be-detected molecule may be served as the probe molecule 15.

From the above discussions, the biochip of the present invention comprises the substrate 10, the photoresist pattern layer 11, the blocking layer 12, the bonding layer 13, the linker molecule 14, and the probe molecule 15. The bonding layer 13 is covalently attached to the photoresist pattern layer 11. The linker molecule 14 is covalently bonded to the binding layer 13. The probe molecule 15 is covalently bonded to the linker molecule 14. That is, the probe molecule 15 is covalently bonded to the photoresist pattern layer 11 through the linker molecule 14 and the binding layer 13. As previously described, the conventional probe molecule is non-covalently bonded to the photoresist. Since the probe molecule 15 is covalently bonded to the photoresist pattern layer 11 according to the present invention, the adhesion between the probe molecule 15 and the photoresist pattern layer 11 is increased. In other words, the stability of the biochip of the present invention is enhanced.

Moreover, the blocking layer 12 of the biochip of the present invention is formed on the surface of the substrate at the region uncovered by the photoresist pattern layer 11. The blocking layer 12 may block the to-be-detected molecule from being attached thereon through a non-specific reaction. Consequently, the precision of the biochip is enhanced. Moreover, the photoresist pattern layer 11 may be produced by a maskless lithography process in order to reduce the fabricating cost and effective minimize the microarray structure. In a case that the photoresist pattern layer 11 is produced by the maskless lithography process, each spot of the microarray structure has a diameter smaller than 300 μm and the fabricating process is simplified.

An example of fabricating the biochip will be illustrated as follows.

### Example 1

### Fabrication of s Biochip of the Present Invention

A glass substrate is provided. A layer of about 5 μm of SU-8 photoresist (in a cyclopentane solvent) is spin-coated onto the glass substrate by a photoresist spinner. The glass substrate is further soft-baked to remove excess solvent. Through the optical path system of a digital micromirror device, a maskless lithography process is performed to expose and activate the SU-8 photoresist. Then, the micro-mirrors of the digital micromirror device are employed to image the SU-8 photoresist. Then, a post-exposure baking process is performed, and the SU-8 photoresist is developed by a SU-8 developing solution. After rinsed with isopropyl alcohol and dried with nitrogen gun, a chip with a SU-8 microarray structure (photoresist layer) is obtained. Each spot of the SU-8 microarray structure has a diameter of about 300 μm.

Then, the chip with the SU-8 microarray structure is placed in a glass Petri dish. After placed at room temperature for a few minutes, a blocking reagent (e.g. dimethyldichlorosilane) is uniformly distributed over the entire chip for about 30 minutes to 1 hour. Since the SU-8 microarray structure has a height of about 5 μm, the blocking reagent readily flows to the surface of the glass substrate without the SU-8 microarray structure. Then, a bonding agent is added to the reaction zone of the SU-8 microarray structure. For example, the bonding agent is 20%(v/v) of 3-[Bis(2-hydroxyethyl)amino] propyl-triethoxysilane dissolved in 95%(v/v) of ethanol. After reacted at room temperature for 1 to 2 hours, a bonding layer is formed on the SU-8 microarray structure. Then, the unreacted bonding agent is washed off by 95% (v/v) of ethanol. After dried at room temperature, the product is stored at 4° C.

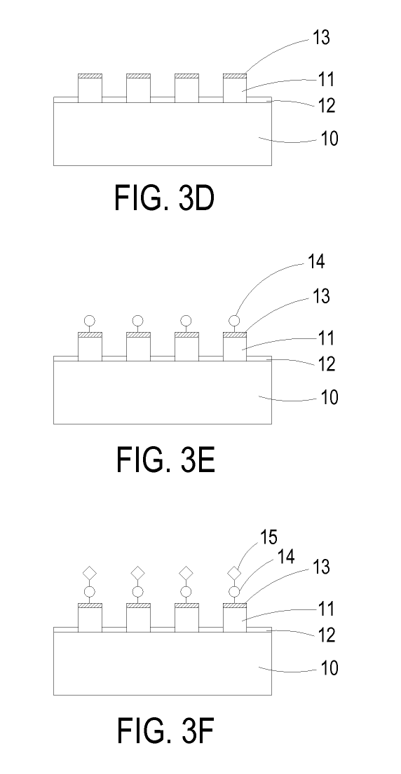

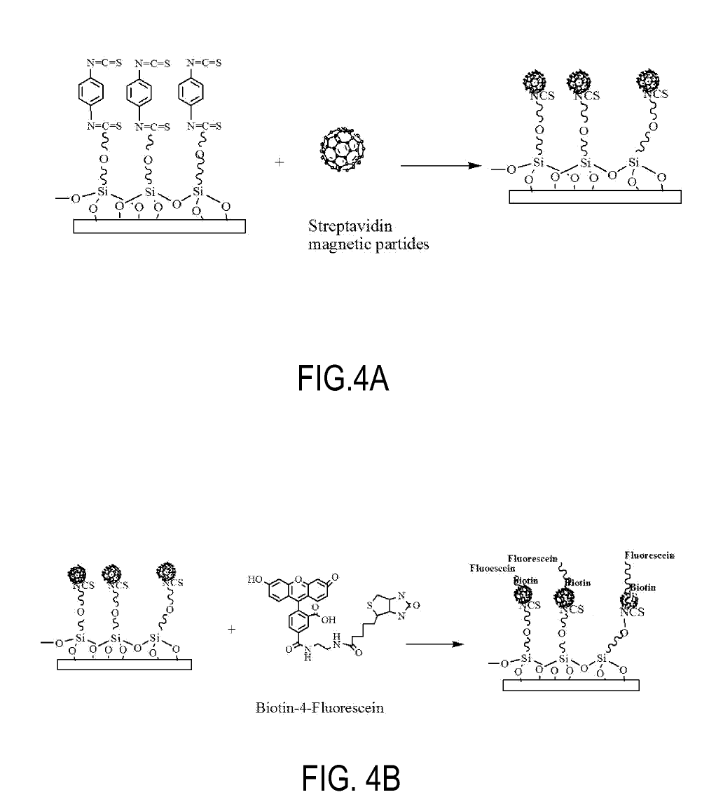

Then, a linker molecule solution is added to the reaction zone of the SU-8 microarray structure. For example, the linker molecule solution is 0.2% of 1,4-phenylene diisothiocyanate (PDITC) dissolved in dimethylformamide (DMF). After reacted at room temperature for 1 to 2 hours, a probe molecule solution is added. In a case that the biochip is used for detecting the reaction between avidin and the biotin, streptavidin magnetic particle is added to the reaction zone of the SU-8 microarray structure. After reacted at room temperature for 30 minutes to 1 hour, the streptavidin magnetic particle is covalently bonded to 1,4-phenylene diisothiocyanate. The reaction between 1,4-phenylene diisothiocyanate and streptavidin magnetic particle is shown in FIG. 4A. The reaction zone is flow-washed by a PBST solution for three times. Meanwhile, the biochip of the present invention is fabricated.

For testing the efficacy of the biochip, five different concentrations of fluorescent-labeled biotin-4-fluorescein solutions are added to different biochips, respectively. After reacted for about 10 to 25 minutes, the biotin-4-fluorescein is covalently bonded to the streptavidin magnetic particle of the biochip through a specific reaction. The reaction between biotin-4-fluorescein and streptavidin magnetic particle is shown in FIG. 4B. By using a scanning system, a quantitative analysis diagram about the relationship between fluorescence intensity and concentration is obtained. From the quantitative analysis diagram (not shown), it was found that the fluorescence intensity is positively correlated to concentration. In other words, the biochip of the present invention has good detecting efficacy.

From the above descriptions, the present invention provides a biochip. Through the bonding layer and the linker molecule, the probe molecule is covalently bonded to the photoresist pattern layer. Consequently, the adhesion between the probe molecule and the photoresist pattern layer is increased, and the stability of the biochip of the present invention is enhanced. Moreover, the blocking layer of the biochip of the present invention is formed on the surface of the substrate at the region uncovered by the photoresist pattern layer. Since the blocking layer 12 may block the to-be-detected molecule from being attached thereon through a non-specific reaction, the precision of the biochip is enhanced. Moreover, the photoresist pattern layer may be produced by a maskless lithography process in order to reduce the fabricating cost and effective minimize the microarray structure. In a case that the photoresist pattern layer is produced by the maskless lithography process, each spot of the microarray structure has a diameter smaller than 300 μm and the fabricating process is simplified.

From the above description, the biochip of the present invention has enhanced precision and stability. Moreover, since the fabricating cost is reduced and the fabricating process is simplified, the applications of the biochip of the present invention are expanded.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A biochip, comprising:
a substrate;
a photoresist pattern layer formed on a surface of said substrate;
a blocking layer formed on said surface of said substrate at a region uncovered by said photoresist pattern layer;
a bonding layer covalently attached to said photoresist pattern layer;
at least one linker molecule covalently bonded to said binding layer; and
a probe molecule covalently bonded to said at least one linker molecule for specifically reacting with a to-be-detected molecule.

2. The biochip according to claim 1, wherein the substrate is a glass substrate, a silicon chip substrate, or a plastic substrate.

3. The biochip according to claim 1, wherein said photoresist pattern layer is made of a SU-8 photoresist material.

4. The biochip according to claim 1, wherein each spot of said photoresist pattern layer has a diameter of about 10-300 μm.

5. The biochip according to claim 1, wherein said photoresist pattern layer is formed by performing a maskless lithography process.

6. The biochip according to claim 1, wherein said blocking layer is made of dimethyldichlorosilane.

7. The biochip according to claim 1, wherein said bonding layer is made of 3-[Bis(2-hydroxyethyl)amino]propyl-triethoxysilane.

8. The biochip according to claim 1, wherein said linker molecule is made of 1,4-phenylene diisothiocyanate.

9. The biochip according to claim 1, wherein said probe molecule is protein or nucleic acid.

10. A method of fabricating a biochip, said method comprising steps of:
(a) providing a substrate;
(b) forming a photoresist pattern layer on a surface of said substrate;
(c) forming a blocking layer on said surface of said substrate at a region uncovered by said photoresist pattern layer;
(d) forming a bonding layer on said photoresist pattern layer, wherein said bonding layer is covalently attached to said photoresist pattern layer;
(e) forming at least one linker molecule on said binding layer, wherein said linker molecule is covalently bonded to said binding layer; and
(f) forming a probe molecule on said linker molecule, wherein said probe molecule is covalently bonded to said linker molecule.
